(19) United States
(12) Patent Application Publication
(10) Pub. No.: US 2008/0127194 A1
(43) Pub. Date: May 29, 2008

(54) Job allocation program and job allocation method

(75) Inventor: Shinichi Onitsuka, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/983,112

(22) Filed: Nov. 7, 2007

(30) Foreign Application Priority Data
Nov. 29, 2006 (JP) 2006-322468

(51) Int. Cl. G06F 9/46

(52) U.S. Cl. 718/103

(57) ABSTRACT

A job allocation program controls each of processors to store a record, which contains job information and a priority, into a table in a memory; to specify the record with the highest priority; to execute the specified job; to delete the record of the executed job from the table; to specify the record with the highest priority among records in tables of other processors when an execution time for the job by the execution function is shorter than a predetermined upper limit; and to move the specified record from the table of another processor to its own table. Accordingly, each processor retrieves an unfinished job with the highest priority allocated to another processor and executes the retrieved job before executing a job allocated to itself, when an execution time for the job is shorter than the predetermined upper limit.

### BACKGROUND OF THE INVENTION

The present invention relates to a program and a method for allocating jobs to a plurality of processors that constitute a tightly coupled multiprocessor system.

As everyone knows, a tightly coupled multiprocessor system means that a plurality of processors that are connected in a bus level share a memory and the respective processors are controlled by a single OS [Operating System] program on the memory. In the tightly coupled multiprocessor system, since a job (task) in the system may be executed by any processor, the system can distribute jobs to the respective processors. Therefore, the tightly coupled multiprocessor system has a throughput higher than that of a single-processor system.

Japanese unexamined patent publications 05-134994 and 11-003321 disclose a technique to allocate jobs to processors. The '944 publication discloses a technique to allocate jobs to processors so as to maximize processing efficiency based on operating conditions of resources like a memory etc. and commands. Thereby, the technique concerning the '944 publication obtains a high cache hit rate. On the other hand, the '321 publication discloses a technique to allocate a job to the processor with the minimum load among processors with a short acquisition-time interval of load information, such as a CPU (Central Processing Unit) activity ratio and a memory activity ratio. Thereby, the technique concerning the '321 publication can prevent the performance degradation of the system.

Incidentally, a priority, which is information for specifying ideal execution order, is given to each job in the system to improve the speed of memory access. In the system disclosed in the '994 publication, each processor executes a job with higher priority first among the allocated jobs.

However, when execution of a job is delayed in a processor for the reason of a lack of a response to an inquiry to an external device, for example, and a job with a low priority is previously executed by another processor, the jobs are executed out of order of the priorities, which reduce the system performance.

In the system disclosed in the '321 publication, one of processors operates as a scheduler that allocates jobs to respective processors based on loads thereof. However, since one processor is occupied as a scheduler, the processor concerned cannot be used to execute another job.

### SUMMARY OF THE INVENTION

The present invention is developed in view of the above-mentioned problems in the prior art. An object of the present invention is to provide an improved job allocation program, which is capable of allocating jobs to processors under low load so that the jobs are executed in the order of priority without occupying a processor as a scheduler.

The job allocation program according to the present invention is accomplished in order to achieve the above-mentioned object. The job allocation program of a first aspect of the present invention controls each of processors that constitute a tightly coupled multiprocessor system to execute functions including: a job storing function for storing a record, which contains job information for specifying a job allocated to the processor concerned and a priority defined for the job, into a table of the processor concerned in a memory; an execution function for specifying the record with the highest priority among records stored in the table and for executing the job that is specified by job information in the specified record; a deletion function for deleting the record corresponding to the job that has been executed by the execution function from the table; a specification function for specifying the record with the highest priority among records in tables of other processors when an execution time for the job by the execution function is shorter than a predetermined upper limit; and a moving function for moving the record specified by the specification function from the table of another processor to the table of the processor concerned.

With this construction, each processor retrieves an unfinished job with the highest priority allocated to another processor and executes the retrieved job before executing a job allocated to the processor concerned, when an execution time for the job is shorter than the predetermined upper limit. Therefore, a job that is allocated to a processor under load is re-allocated to a processor that has executed the job in short time. As a result, the system performance can be kept high and jobs are possibly executed in the order of priority. In addition, since each processor retrieves a job that can be re-allocated to itself before an execution of a job, any processor is not occupied as a scheduler.

The job allocation program of a second aspect of the present invention controls each of processors that constitute a tightly coupled multiprocessor system to execute functions including: a job storing function for storing a record, which contains job information for specifying a job allocated to the processor concerned and a priority defined for the job, into a table of the processor concerned in a memory; an execution function for executing the job that is specified by job information in the record with the highest priority among records stored in the table; a determination function to determine a record with the next highest priority as a next execution target among records stored in the table when the execution function starts an execution of a job; a search function for searching tables of other processors for a record whose priority is lower than that of the next execution target and whose job has been executed, when a predetermined time elapses since the determination function determines the next execution target; and a delivery function for delivering the record of the next execution target from the table of the processor concerned to the table of the processor that contains the record with the highest priority among the detected records when the search function can detect a record.

With this construction, when a standby time of the job of the next execution target is longer than the predetermined upper limit, the processor searches a job whose priority is lower than that of the job of the next execution target from the jobs that have been already executed by the other processors before executing the job of the next execution target. Then, the processor delivers the job of the next execution target to the other processor that executed the job with lower priority. Therefore, a processor under load delivers the job of the next execution target to a processor that has executed the job whose priority is lower than the job of the next execution target. As a result, the system performance can be kept high and jobs are possibly executed in the order of priority. In addition, since each processor retrieves a processor to which a job of itself is delivered during an execution of a job, any processor is not occupied as a scheduler.

As described above, according to the present invention, a job can be allocated to processors under low load so that the jobs are executed in the order of priority without occupying a processor as a scheduler.

### DESCRIPTION OF THE ACCOMPANYING DRAWINGS

FIG. 1 is a block diagram of the computer of the first embodiment according to the present invention,

FIG. 2 shows an example of a data structure of a job management table in the first embodiment,

FIG. 3 shows an example of a data structure of a condition management table in the first embodiment,

FIG. 4 is a flowchart showing a job allocation program in the first embodiment,

FIG. 5 is a flowchart showing a process executed by a processor in the first embodiment,

FIG. 6 is a flowchart showing a condition recording process in the first embodiment,

FIG. 7 is a flowchart showing a job selection process in the first embodiment,

FIG. 8 is a flowchart showing a job deletion process in the first embodiment

FIG. 9 is a time chart showing re-allocation of a job from one processor to another processor in the first embodiment,

FIG. 10 is a block diagram of the computer of the second embodiment according to the present invention,

FIG. 11 shows an example of a data structure of a job management table in the second embodiment

FIG. 12 is a flowchart showing a process executed by a processor in the second embodiment,

FIG. 13 is a flowchart showing a job selection process in the second embodiment,

FIG. 14 is a flowchart showing a job deletion process in the second embodiment,

FIG. 15 is a flowchart showing a load monitoring process in the second embodiment,

FIG. 16 is a flowchart showing a first half of an allocation subroutine in the second embodiment,

FIG. 17 is a flowchart showing a second half of the allocation subroutine in the second embodiment, and

FIG. 18 shows examples of the job management tables of three processors when a job allocated to one processor is re-allocated to another processor in the second embodiment.

### DESCRIPTION OF THE PREFERRED EMBODIMENTS

Hereafter, two embodiments of the present invention will be described with reference to the accompanying drawings.

### First Embodiment

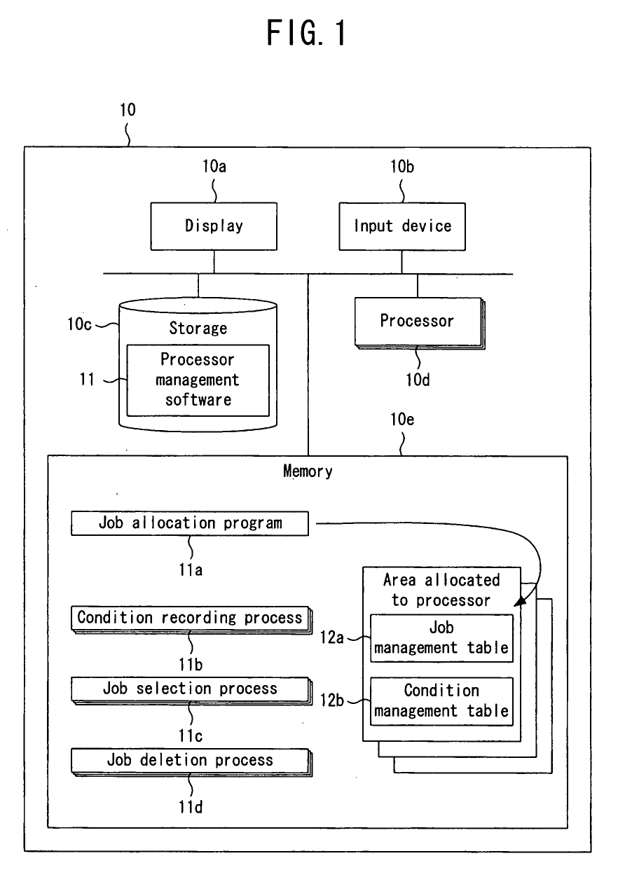

First, a configuration of a computer of the first embodiment will be described. FIG. 1 is a block diagram of a computer 10 of the first embodiment.

The computer 10 of the first embodiment consists of a display 10a such as a liquid crystal display, input devices 10b such as a keyboard and a mouse, and a main part to which these devices 10a and 10b are connected. And the main part contains storage 10c, a processor 10d, and a memory 10e. The storage 10c stores various kinds of application programs and data. The processor 10d is a processing unit that processes according to the programs in the storage 10c. Memory 10e is volatile storage with which the cache of the program is carried out, or a working area is developed, when processor 10d processes.

A plurality of processors 10d are connected to the memory 10e through a bus so that the processors 10d share the memory 10e in the computer 10. OS (Operating System) software is installed in the storage 10c to provide output control in the display 10a, input control in the input devices 10b, a memory area management in the memory 10e, and a user interface to the application programs. The OS software includes processor management software 11 that operates the respective processors 10d as a tightly coupled multiprocessor.

The processor management software 11 allocates exclusive areas having a predetermined size of the memory 10e to the processors 10d, respectively. The processor management software 11 also generates a job management table 12a and a condition management table 12b of each of the processors 10d, and stores the tables in an exclusive area that is allocated to each processor. The processor management software 11 includes a job allocation program 11a, a condition recording process 11b, a job selection process 11c, and a job deletion process 11d as programs for allocating a job (task) to the respective processors 10d. FIG. 1 shows a condition where the program 11a, the processes 11b through 11d, and the areas allocated to the respective processors are developed.

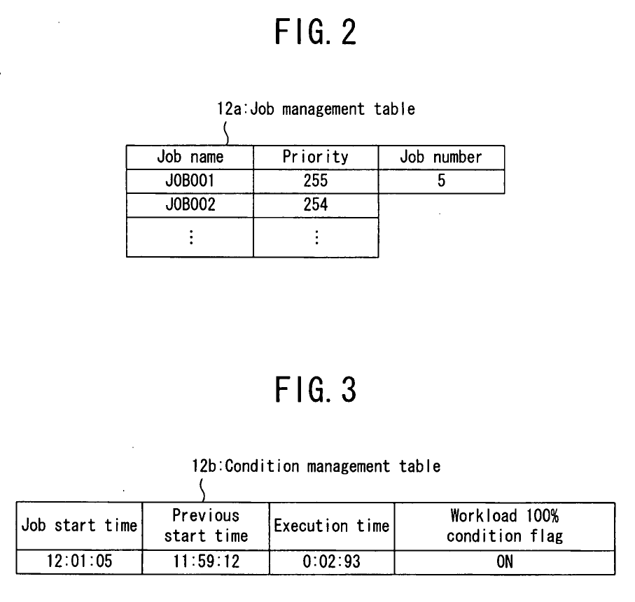

FIG. 2 shows an example of a data structure of the job management table 12a.

The job management table 12a stores the information about the jobs assigned to the processors 10d by the below-mentioned job allocation program 11a. As shown in FIG. 2, the job management table 12a has the same number of records as the jobs allocated to the corresponding processor 10d. Each record has fields of a “job name” and a “priority”. The “job name” field stores a job name that is an identifier to specify a job. The “priority” field stores a priority defined as a unique value to specify an ideal execution order of each job in the computer 10. In the first embodiment, the larger the value of the priority is, the higher the priority becomes. The job management table 12a has a separate field for recording the number of the jobs registered. The processor 10d that stores the information about the job into the job management table 12a corresponds to the job storing function mentioned above.

FIG. 3 shows an example of the data structure of the condition management table 12b.

The condition management table 12b stores information about job executions by the corresponding processor 10d. As shown in FIG. 3, the condition management table 12b has one record that includes fields of a “job start time”, a “previous start time”, an “execution time”, and a “workload 100% condition flag”. The “job start time” field stores a start time of an execution of a job. The “previous start time” field stores a start time of an execution of the job that has been just executed. The “execution time” field stores the time required to execute the job that has been just executed. The “workload 100% condition flag” field stores a flag to specify whether the execution time of the job that has been just executed is longer than a predetermined time or not.

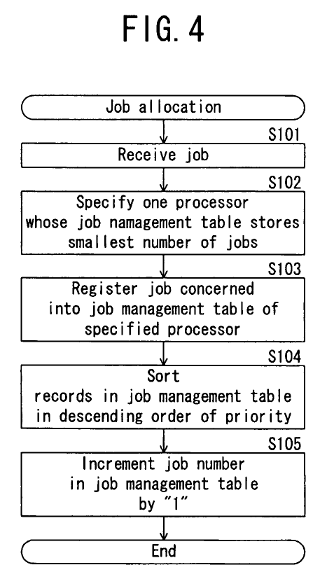

The job allocation program 11a assigns the job generated by an input operation of an operator like a click of an icon to one of the processors 10d. The processes by the job allocation program 11a are generated for each of the processors 10d, as shown in FIG. 1. The contents of the job allocation process, which is executed by the processor according to the program 11a, will be described with reference to FIG. 4.

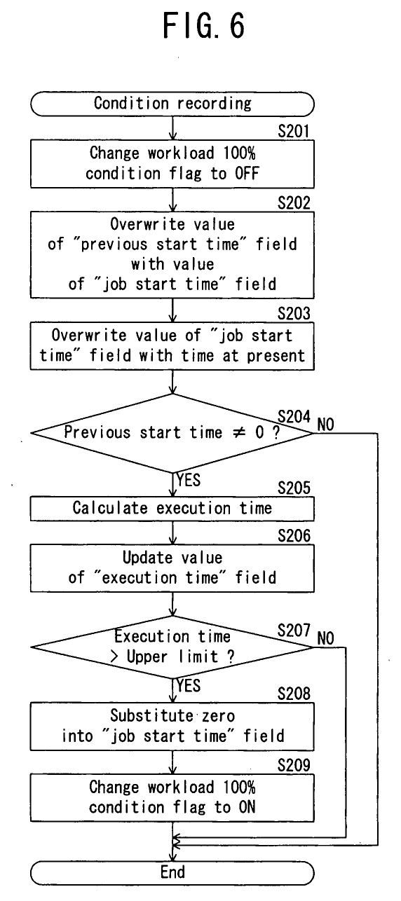

The condition recording process 11b records information about a job execution into the condition management table 12b shown in FIG. 3. The condition recording process 11b is also generated for each of the processors 10d, as shown in FIG. 1. The contents of the condition recording process 11b, which is executed by the processor according to the program, will be described with reference to FIG. 6.

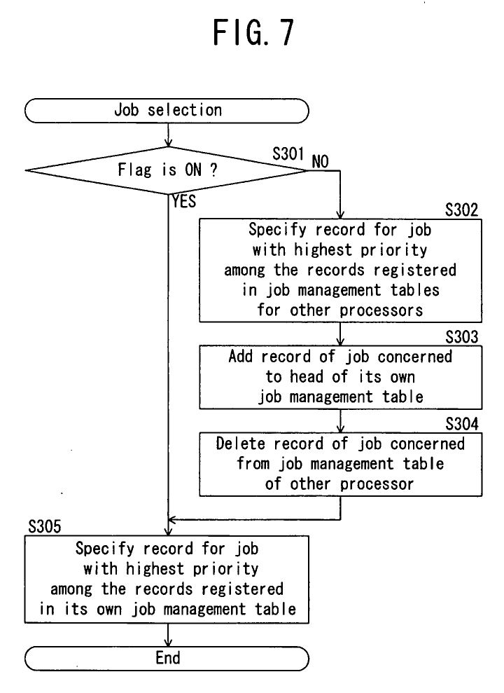

The job selection process 11c determines a job that should be executed by the corresponding processor according to the contents of the condition management table 12b of FIG. 3. The job selection program 11c is also generated for each of the processors 10d, as shown in FIG. 1. The contents of the job selection process 11c, which is executed by the processor according to the program, will be described with reference to FIG. 7.

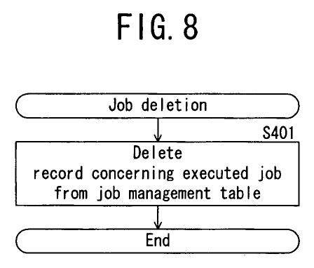

The job deletion process 11d deletes a record concerning a job that has been executed from the job management table 12a of FIG. 2. The job deletion process 11d is also generated for each of the processors 10d, as shown in FIG. 1. The contents of the job deletion process 11d, which is executed by the processor according to the program, will be described with reference to FIG. 8.

Next, the processing executed in the computer 10 of the first embodiment will be described.

As mentioned above, the job allocation program 11a starts at the time when a job is generated by an input operation by an operator.

FIG. 4 is a flowchart showing the processing by the job allocation program 11a.

In the first step S101 of the processing, the processor group 10d receives a job through the OS software. A priority has been already defined in the job.

In the next step S102, the processor group 10d specifies one processor whose job management table 12a stores the smallest number of jobs.

In the next step S103, the processor group 10d registers the information, which specifies the job received in step S101, into the job management table 12a of the processor specified in step S102.

In the next step S104, the processor group 10d sorts the records, which are stored in the job management table 12a into which the job is registered in step S103, in descending order of the priority.

In the next step S105, the processor group 10d increments the job number, which is stored in the job management table 12a whose records are rearranged in step S104, by “1”. Then, the processor group 10d finishes the job allocation program of FIG. 4.

According to the job allocation process, a newly generated job is allocated to a processor 10d to which the smallest number of jobs are allocated.

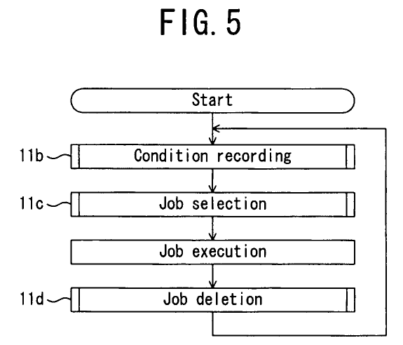

FIG. 5 is a flowchart showing a processing executed by a processor 10d.

As shown in FIG. 5, every processor 10d repeatedly executes the condition recording process 11b, the job selection process 11c, the job execution process, the job deletion process 11d in this order.

FIG. 6 is a flowchart showing the condition recording process 11b.

In the first step S201, the condition recording process 11b, which is executed by a processor according to the program, changes the workload 100% condition flag contained in the record in the condition management table 12b of FIG. 3 to OFF.

In the next step S202, the condition recording process 11b updates the value in the “previous start time” field by overwriting with the value in the “job start time” field of the record in the condition management table 12b of FIG. 3.

In the next step S203, the condition recording process 11b updates the value in the “job start time” field of the record in the condition management table 12b of FIG. 3 by overwriting with the time of the point in time.

In the next step S204, the condition recording process 11b determines whether the value in the “previous start time” field is zero. And when the value of the “previous start time” field is zero, the condition recording process 11b branches the processing from step S204, and finishes the condition recording process concerning FIG. 6. On the other hand, when the value of the “previous start time” field is not zero, the condition recording process 11b advances the processing to step S205.

In step S205, the condition recording process 11b calculates an execution time. Specifically, the condition recording process 11b calculates the execution time by subtracting the value of the “previous start time” field from the value of the “job start time” field of the record in the condition management table 12b of FIG. 3.

In the next step S206, the condition recording process 11b updates the value of the “execution time” field of the record in the condition management table 12b of FIG. 3 by overwriting with the execution time calculated in step S205.

In the next step S207, the condition recording process 11b determines whether the execution time calculated in step S205 is longer than a predetermined upper limit. When the execution time concerned is shorter than the predetermined upper limit, the condition recording process 11b branches the processing from step S207, and finishes the condition recording process concerning FIG. 6. On the other hand, when the execution time concerned is longer than the predetermined upper limit, the condition recording process 11b advances the processing to step S208.

In step S208, the condition recording process 11b substitutes zero into the “job start time” field of the record in the condition management table 12b of FIG. 3.

In the next step S209, the condition recording process 11b changes the workload 100% condition flag contained in the record in the condition management table 12b of FIG. 3 to ON. Then, the condition recording process 11b finishes the processing concerning FIG. 6.

According to the condition recording process, in advance of an execution of a job, the information about the previous job that has been just executed is recorded into the condition management table 12b of FIG. 3, and it is determined whether the workload 100% condition flag should be changed.

FIG. 7 is a flowchart showing the job selection program 11c.

At the first step S301, the job selection process 11c, which is executed by the processor according to the program, determines whether the workload 100% condition flag contained in the record in the condition management table 12b of FIG. 3 is ON. When the workload 100% condition flag is ON, the job selection process 11c advances the processing to step S305. On the other hand, when the workload 100% condition flag is OFF, the job selection process 11c branches the processing from step S301 to step S302.

In step S302, the job selection process 11c specifies the record for the job with the highest priority among the records registered in the job management tables 12a of all the processors except the processor concerned.

In the next step S303, the job selection process 11c copies the record specified in step S302, and additionally registers the copied record to the head of the job management table 12a of the processor concerned (i.e., its own job management table).

In the next step S304, the job selection process 11c deletes the record specified at step S302 from the job management table 12a that contains the specified record. Then, the job selection process 11c advances the processing to step S305.

In step S305, the job selection process 11c specifies the record of the job with the highest priority as a record for the next execution target among the records in the job management table 12a of FIG. 2 for the processor concerned. Then, the job selection process 11c finishes the processing concerning FIG. 7. The processor 10d that executes step S305 corresponds to the execution function mentioned above.

According to the job selection process, the next job that should be executed by the processor 10d concerned is specified.

The processor 10d that executes steps S201 through S209 and steps S301 and S302 corresponds to the specification function mentioned above. Further, the processor 10d that executes steps S303 and S304 corresponds to the movement function mentioned above.

FIG. 8 is a flowchart showing the job deletion process 11d.

At the first step S401, the job deletion process 11c, which is executed by the processor according to the program, deletes the record concerning the executed job from the job management table 12a of FIG. 2. Then, the job deletion process 11d finishes the processing of FIG. 8. The processor 10d that executes the step S401 corresponds to the deletion function mentioned above.

According to the job deletion process, the executed job is removed from the jobs allocated to the processor 10d.

Next, an operation and an effect of the computer 10 of the first embodiment will be described.

Each processor 10d of the computer 10 executes the condition recording process 11b and the job selection process 11c in this order, before executing the job allocated to itself by the job allocation program 11a. In the condition recording process 11b, a loaded condition of each processor 10d is judged by determining whether the execution time of the previous job is longer than the upper limit (step S207). When the load is determined low due to the short execution time, the job selection process 11c searches a job with the highest priority among the jobs allocated to the other processors (steps S302-S304), and specifies the searched job as a next execution target.

Since each processor 10d operates in such a manner, the job that is allocated to a processor under load is re-allocated to a processor 10d that has executed the job in short time.

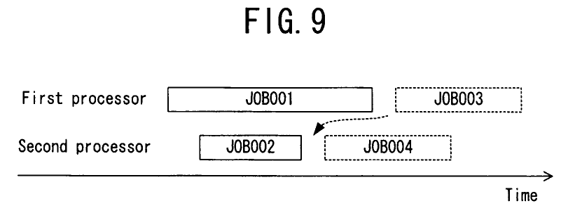

FIG. 9 is a time chart showing re-allocation of a job from one processor 10d to another processor 10d.

In the example shown in FIG. 9, the first processor executes the job of “JOB001”, and the second processor executes the job of “JOB002” at first. When the second processor finishes the execution of the job of “JOB002”, the first processor 10d continues to execute the job of “JOB001”. After finishing the job of “JOB002”, the second processor executes the condition recording process 11b before executing the job of “JOB004” that is allocated to the second processor. If the condition reading process 11b judges that a load is low (S207; NO, S301; NO), the second processor executes the job of “JOB003” that should be executed next by the first processor (S302-S304).

As a result of such an operation, the system performance can be kept high and jobs are possibly executed in the order of priority. In addition, since each processor 10d retrieves a job that can be executed by itself before executing a job, any processor 10d is not occupied as a scheduler.

### Second Embodiment

In the second embodiment, each processor determines whether a job of a next execution target should be delivered to another processor based on a standby condition of the job during execution of a previous job. This is different from the first embodiment in which each processor determines whether it should execute a job allocated to another processor based on an execution condition of a previous executed job. However, the remaining portions of the second embodiment are identical to that of the first embodiment.

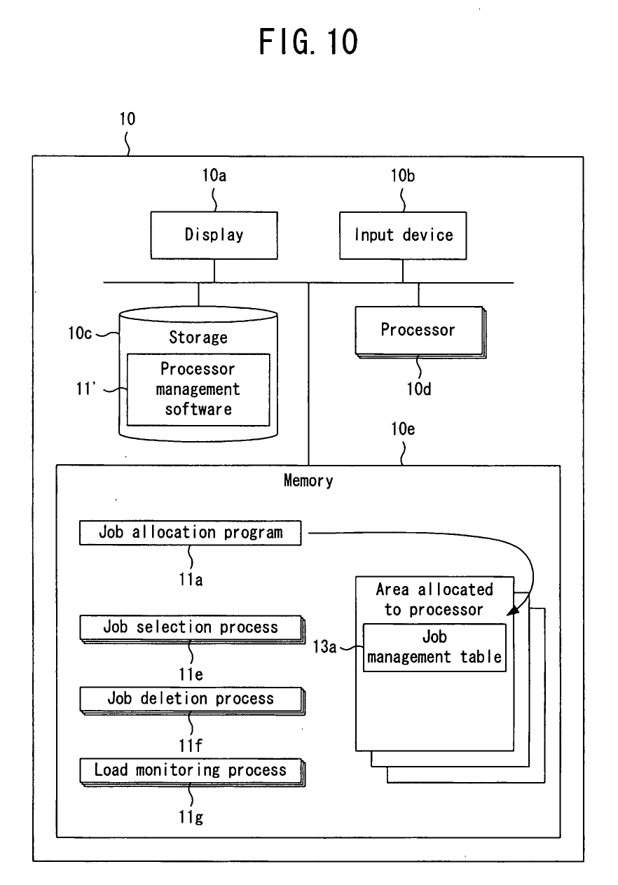

FIG. 10 is a block diagram of a computer 10 of the second embodiment.

As is evident from a comparison of FIG. 1 and FIG. 10, the computer 10 of the second embodiment has the same hardware configuration as the first embodiment.

In the second embodiment, the processor management software 11′ does not contain the condition recording process 11b, but contains a load monitoring process 11g instead of it. For this reason, a reference number given to the processor management software of the second embodiment is different from that in the first embodiment.

Since contents of the job selection process 11e and the job deletion process 11f in the second embodiment are slightly different from that in the first embodiment, the reference numbers given to these processes in the second embodiment is different from that in the first embodiment.

Only a job management table 13a is set in the memory area of the predetermined size allocated to each processor 10d in the memory 10e.

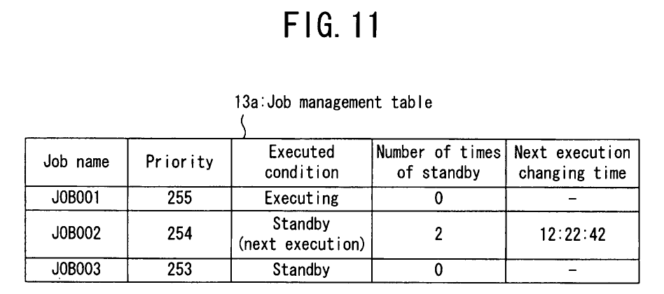

FIG. 11 shows one example of the data structure of the job management table 13a in the second embodiment.

As shown in FIG. 11, the job management table 13a has the same number of records as the jobs allocated to the corresponding processor 10d. Each record has fields of a “job name”, a “priority”, an “executed condition”, the “number of times of standby”, and a “next execution changing time”. The “job name” field stores a job name that is an identifier to specify a job. The “priority” field stores a priority defined as a unique value to specify an ideal execution order of each job in the computer 10. In the second embodiment, the larger the value of the priority is, the higher the priority becomes, too. The “executed condition” field stores information that specifies the condition of the job. In this field, an “executing”, a “standby (next execution)”, a “standby”, or an “executed” is stored. The “number of times of standby” field stores the number of times that the below-mentioned load monitoring process 11g detects the “standby” condition when the process is executed periodically. The “next execution changing time” field stores a time when an executed condition is changed from the “standby” to the “standby (next execution)”. The processor 10d that stores the information about a job into the job management table 13a corresponds to the job storing function mentioned above.

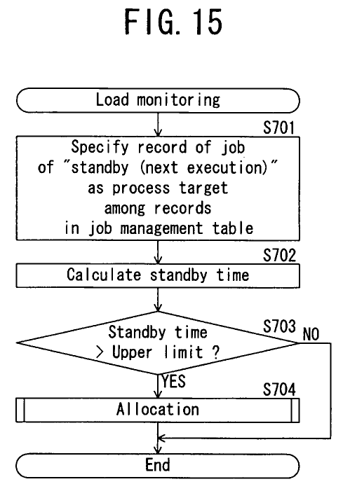

The load monitoring process 11g determines whether it delivers a job to another processor 10d based on the number of times of standby of the job whose executed condition matches the “standby (next execution)” in the job management table 13a. The processing is generated by the load monitoring process 11g for each processor 10d, as shown in FIG. 10. The contents of the load monitoring process 11g, which is executed by a processor according to the program, will be described below with reference to FIGS. 15 through 17.

Next, the processing executed in the computer 10 of the second embodiment is described.

The job allocation program 11a exhibits the same function as that of the first embodiment. Therefore, a processing of the job allocation program 11a is generated when a job is generated by an input operation by an operator. A newly generated job is allocated to a processor 10d to which the smallest number of jobs have been allocated.

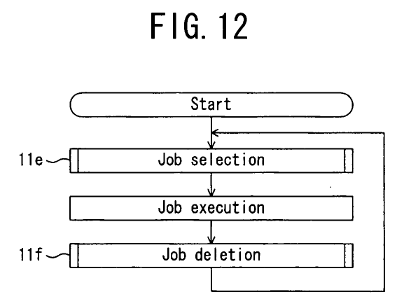

FIG. 12 is a flowchart showing the processing executed by the processor 10d.

As shown in FIG. 12, every processor 10d repeatedly executes the job selection process 11e, the job execution process, and the job deletion process 11f in this order. The load monitoring processes 11g is executed concurrently with the loop that contains the job selection process 11e, the job execution process, and the job deletion process 11f.

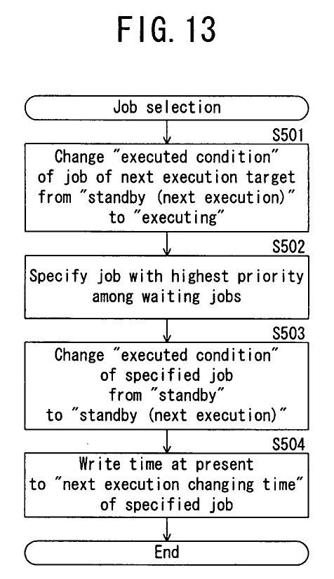

FIG. 13 is a flowchart showing the job selection process 11e.

In the first step S501, the job selection process 11e, which is executed by the processor according to the program, specifies a record whose value in the “executed condition” field is the “standby (next execution)” among the records in the job management table 13a of FIG. 11. And then, the process 11e changes the value of the “executed condition” field of the specified record from the “standby (next execution)” to the “executing”.

In the next step S502, the job selection process 11e specifies a record of a job with the highest priority among the records whose values in the “executed condition” fields are the “standby” in the job management table 13a of FIG. 11.

In the next step S503, the job selection process 11e changes the value of the “executed situation” field of the record specified in step S502 from “standby” to the “standby (next execution)”.

In the next step S504, the job selection process 11e updates the value in the “next execution changing time” field of the record specified in step S502 by overwriting with the time of the point in time. Then, the job selection process 11e finishes the processing concerning FIG. 13.

According to the job selection processing, the next job that should be executed is determined just before an execution of the job. The processor 10d that executes the job selection process corresponds to the determination function mentioned above.

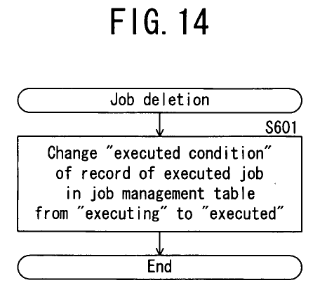

FIG. 14 is a flowchart showing the job elimination process 11f.

In the first step S601, the job deletion process 11f, which is executed by the processor according to the program, changes the value of the “executed condition” field of the record concerning the executed job in the job management table 13a of FIG. 11 from the “executing” to the “executed”. Then, the job deletion process 11f finishes the processing concerning FIG. 14.

According to the job deletion process, the executed job is removed from the jobs allocated to the processor 10d.

FIG. 15 is a flowchart showing the load monitoring process 11g.

In the first step S701, the load monitoring process 11g, which is executed by the processor according to the program, specifies a record whose value in the “executed condition” field is the “standby (next execution)” as a process-target among the records in the job management table 13a of FIG. 11.

In the next step S702, the load monitoring process 11g calculates a standby time. Specifically, the load monitoring process 11g calculates the standby time by subtracting the time of the point in time from the value of the “next execution changing time” field of the record specified in step S701.

In the next step S703, the load monitoring process 11g determines whether the standby time calculated in step S702 is longer than a predetermined upper limit. When the standby time is shorter than the predetermined upper limit, the load monitoring process 11g branches the processing from step S703, and finishes the processing concerning FIG. 11. On the other hand, when the standby time is longer than the predetermined upper limit, the load monitoring process 11g advances the processing to step S704.

In step S704, the load monitoring process 11g executes an allocation subroutine.

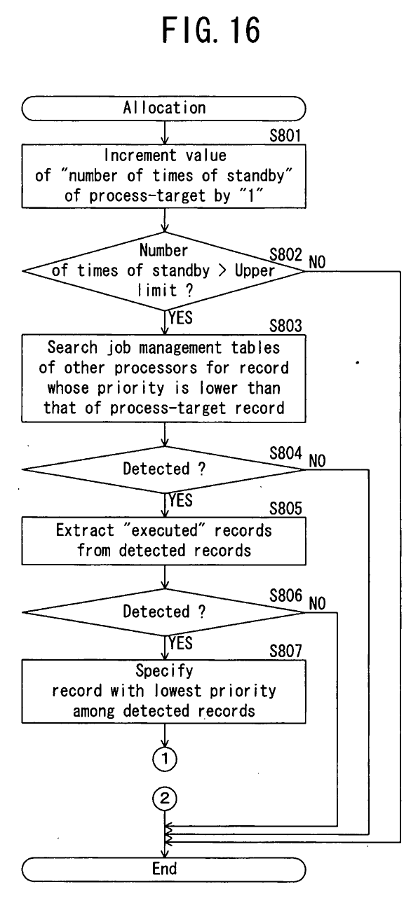

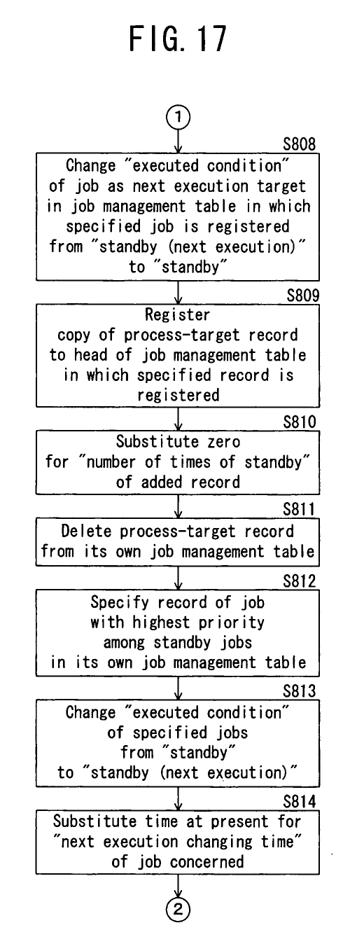

FIGS. 16 and 17 are flowcharts showing the allocation subroutine.

In the first step S801, the load monitoring process 11g increments the value of the “number of times of standby” field of the process-target record specified in step S701 by “1”.

In the next step S802, the load monitoring process 11g determines whether the value of the “number of times of standby” field of the process-target record is larger than a predetermined upper limit. And when the value of the “number of times of standby” field of the process-target record is less than the predetermined upper limit, the load monitoring process 11g branches the processing from step S802, finishes the allocation subroutine concerning FIGS. 16 and 17, and finishes the processing concerning FIG. 15. On the other hand, when the value of the “number of times of standby” field of the process-target record is larger than the predetermined upper limit, the load monitoring process 11g advances the processing to step S803.

In step S803, the load monitoring process 11g searches the job management tables 13a of all the processors except the processor concerned for a record whose priority is lower than that of the process-target record.

In the next step S804, the load monitoring process 11g determines whether a record has been detected as a result of the search in step S803. When a record could not be detected, the load monitoring process 11g branches the processing from step S804, finishes the allocation subroutine concerning FIGS. 16 and 17, and finishes the processing concerning FIG. 15. On the other hand, when a record could be detected, the load monitoring process 11g advances the processing to step S805.

In step S805, the load monitoring process 11g extracts a record of which job is “executed” from the records detected in step S804.

In the next step S806, the load monitoring process 11g determines whether a record has been detected as a result of the search in step S805. When a record could not be detected, the load monitoring process 11g branches the processing from step S806, finishes the allocation subroutine concerning FIGS. 16 and 17, and finishes the processing concerning FIG. 15. On the other hand, when a record could be detected, the load monitoring process 11g advances the processing to step S807.

The processor 10d that executes steps S803 through S806 corresponds to the search function mentioned above.

In step S807, the load monitoring process 11g specifies the record of the job with the lowest priority among the records detected in step S806.

In the next step S808, the load monitoring process 11g changes the value of the “executed condition” field of the record of the job as the next execution target in the job management table 13a in which the job specified in step S807 is registered from the “standby (next execution)” to the “standby”.

In the next step S809, the load monitoring process 11g additionally registers a copy of the process-target record specified in step S701 to the head of the job management table 13a in which the record specified in step S807 is registered.

In the next step S810, the load monitoring process 11g substitutes zero for the value of the “number of times of standby” field of the record that is added to the job management table 13a of another processor 10d in step S809. The load monitoring process 11g updates the value of the “next execution changing time” field of the record concerned by overwriting with the time of the point in time.

In the next step S811, the load monitoring process 11g deletes the process-target record from its own job management table 13a.

In the next step S812, the load monitoring process 11g specifies the record of the job with the highest priority among the records of the “standby” job in its own job management table 13a.

In the next step S813, the load monitoring process 11g changes the value of the “executed condition” field of the record specified in step S811 from the “standby” to the “standby (next execution)”.

In the next step S814, the load monitoring process 11g updates the value of the “next execution changing time” field of the record specified in step S811 by overwriting with the time of the point in time. Then, the load monitoring process 11g finishes the allocation subroutine concerning FIGS. 16 and 17, and finishes the processing concerning FIG. 15.

According to the load monitoring process, a job that is waiting for long time as a next execution target is delivered to another processor.

Next, an operation and an effect of the computer 10 of the second embodiment will be described.

Each processor 10d of the computer 10 specifies a job that should be executed next to the current job before executing the current job. Each processor 10d periodically executes the load monitoring process 11g concurrently with this. The number of times of the execution of the load monitoring process 11g is counted during the standby of the job of the next execution target (step S801). When the number of times is larger than the predetermined upper limit (step S802; YES), the job of the next execution target is delivered to the processor that finished the execution of the job whose priority is lower than that of the job of the next execution target (steps S803 through S811).

Since each processor 10d operates in this way, a standby job that should be executed by a processor under load is executed by a processor that has finished the execution of a job whose priority is lower than the standby job.

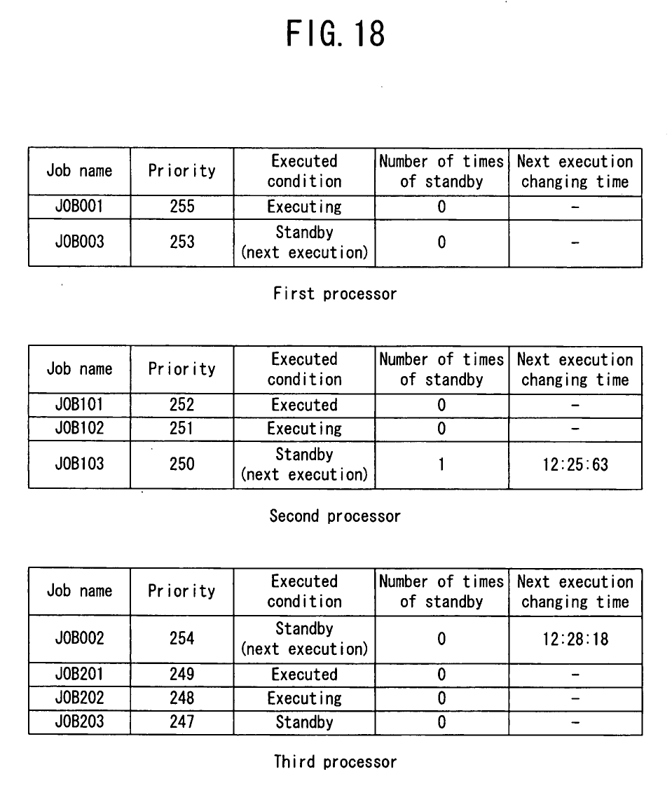

FIG. 18 shows examples of the job management tables of three processors when a job allocated to one processor is re-allocated to another processor.

In examples shown in FIG. 18, the jobs of “JOB001” through “JOB003” are allocated to the first processor, the jobs of “JOB101” through “JOB103” are allocated to the second processor, and the jobs of “JOB201” through “JOB203” are allocated to the third processor. For the first processor, the job of “JOB001” is executing and the job of “JOB002” is waiting as a next execution target. For the second processor, the job of “JOB101” has been executed, the job of “JOB102” is executing, and the job of “JOB103” is waiting as a next execution target. For the third processor, the job of “JOB201” has been executed, the job of “JOB202” is executing, and the job of “JOB203” is waiting as a next execution target.

When the number of times of standby of the job of “JOB002” exceeds the predetermined number of times during execution of the job of “JOB001” (step S802; YES), the executed jobs of “JOB101” and “JOB201” whose priority is lower than the priority “254” of the job of “JOB002” are retrieved from the job management tables 13a of the second and third processors (steps S803 through S806). Then, the job of “JOB002” is registered to the job management table of the third processor at the preceding position of the job of “JOB201” with the lowest priority among the retrieved jobs (step S809). That is, the job of “JOB002” is delivered from the first processor to the third processor. The third processor executes the delivered job of “JOB002” after finishing the execution of the job of “JOB202”, before executing the job of “JOB203.”

As a result of the operation, the system performance can be kept high and jobs are possibly executed in the order of priority. In addition, since each processor retrieves a processor to which a job of itself is delivered during an execution of a job, any processor is not occupied as a scheduler.

What is claimed is:

1. A computer readable medium containing a job allocation program to control each of processors that constitute a tightly coupled multiprocessor system, said program executing functions comprising:
a job storing function for storing a record, which contains job information for specifying a job allocated to the processor concerned and a priority defined for said job, into a table of the processor concerned in a memory;
an execution function for specifying the record with the highest priority among records stored in said table and for executing the job that is specified by job information in the specified record;
a deletion function for deleting the record corresponding to the job that has been executed by said execution function from said table;
a specification function for specifying the record with the highest priority among records in tables of other processors when an execution time for the job by said execution function is shorter than a predetermined upper limit; and
a moving function for moving the record specified by said specification function from the table of another processor to the table of the processor concerned.

2. A job allocation method to control each of processors that constitute a tightly coupled multiprocessor system, said method comprising:
a job storing procedure for storing a record, which contains job information for specifying a job allocated to the processor concerned and a priority defined for said job, into a table of the processor concerned in a memory;
an execution procedure for specifying the record with the highest priority among records stored in said table and for executing the job that is specified by job information in the specified record;
a deletion procedure for deleting the record corresponding to the job that has been executed by said execution procedure from said table;
a specification procedure for specifying the record with the highest priority among records in tables of other processors when an execution time for the job by said execution procedure is shorter than a predetermined upper limit; and
a moving procedure for moving the record specified by said specification procedure from the table of another processor to the table of the processor concerned.

3. A computer readable medium containing a job allocation program to control each of processors that constitute a tightly coupled multiprocessor system, said program executing functions comprising:
a job storing function for storing a record, which contains job information for specifying a job allocated to the processor concerned and a priority defined for said job, into a table of the processor concerned in a memory;
an execution function for executing the job that is specified by job information in the record with the highest priority among records stored in said table;
a determination function to determine a record with the next highest priority as a next execution target among records stored in said table when said execution function starts an execution of a job;
a search function for searching tables of other processors for a record whose priority is lower than that of the next execution target and whose job has been executed, when a predetermined time elapses since said determination function determines the next execution target; and
a delivery function for delivering the record of the next execution target from the table of the processor concerned to the table of the processor that contains the record with the highest priority among the detected records when said search function can detect a record.

4. A job allocation method to control each of processors that constitute a tightly coupled multiprocessor system, said method comprising:
a job storing procedure for storing a record, which contains job information for specifying a job allocated to the processor concerned and a priority defined for said job, into a table of the processor concerned in a memory;
an execution procedure for executing the job that is specified by job information in the record with the highest priority among records stored in said table;
a determination procedure to determine a record with the next highest priority as a next execution target among records stored in said table when said execution procedure starts an execution of a job;
a search procedure for searching tables of other processors for a record whose priority is lower than that of the next execution target and whose job has been executed, when a predetermined time elapses since said determination procedure determines the next execution target; and
a delivery procedure for delivering the record of the next execution target from the table of the processor concerned to the table of the processor that contains the record with the highest priority among the detected records when said search procedure can detect a record.
